(19) United States
(12) Patent Application Publication
(10) Pub. No.: US 2012/0023728 A1
(43) Pub. Date: Feb. 2, 2012

(54) Apparatus And Methods For Transporting Large Photovoltaic Modules

(75) Inventors: Eric B. Britcher, San Jose, CA (US); Kevin L. Cunningham, Mountain Wiew, CA (US)

(73) Assignee: Applied Materials, Inc., Santa Clara, CA (US)

(21) Appl. No.: 13/160,869

(22) Filed: Jun. 15, 2011

Related U.S. Application Data
(60) Provisional application No. 61/357,714, filed on Jun. 23, 2010.

(51) Int. Cl. B62B 3/06; B23P 11/00

(52) U.S. Cl. 29/428; 254/2 R

(57) ABSTRACT

Embodiments of the invention are directed to dollies for moving photovoltaic modules comprising an elongate base section with a first plurality of rollers and a support section movably coupled with the elongate base section such that the support section can be moved upwardly and downwardly to raise and lower a photovoltaic module. Kits including at least two dollies and methods of using the dollies and kits are also described.

### CROSS-REFERENCE TO RELATED APPLICATIONS

This application claims priority under 35 U.S.C. §119(e) to U.S. Provisional Application No. 61/357,714, filed Jun. 23, 2010.

### BACKGROUND

Embodiments of the present invention generally relate to apparatus and methods of moving photovoltaic modules. Specific embodiments pertain to dollies for moving photovoltaic modules and methods of moving photovoltaic modules and assembling solar farms.

Thin film photovoltaic modules, also called solar modules, are made up of a plurality of individual thin film solar cells, or photovoltaic cells, connected in series. Fully assembled photovoltaic modules, especially large size modules, are heavy and can be difficult to install.

For example, the size and mass of 5.7 m² photovoltaic modules are too great for efficient and safe installation by human labor alone, which is the current installation method for smaller photovoltaic modules. While modules of this size can be installed by human labor alone, it is not particularly efficient and can easily result in an unacceptable amount of module breakage. To date, non-manual installation has generally required the use of specialized equipment, specifically a large crane or boom truck. Three main issues exist with these modes of installation: (1) the terrain and soil conditions (e.g., mud) may make the use of large equipment difficult; (2) in certain economic areas (e.g., China) the total installation cost using specialized equipment is much higher than if done by manual labor; and (3) for rooftop installations, the crane must be very large and all movements conducted blindly (via radio), increasing installation times and making rooftop installation of large modules less attractive.

Therefore, there is a need for apparatus and methods for safely transporting and placing modules in a solar farm which minimizes the use of large equipment and makes smart, effective use of manual labor.

### SUMMARY OF THE INVENTION

One or more embodiments of the present invention are directed to a dolly, or dollies, for moving a planar photovoltaic module having a plurality of spaced rails supporting a back side of the photovoltaic module. The dolly comprises an elongate base section and a support section. The elongate base section has an axial length and a first plurality of rollers mounted along the axial length of the elongate base section. The support section is movably coupled with the elongate base section such that the support section can be moved upwardly and downwardly to raise and lower the photovoltaic module. The support section includes a plurality of cradles spaced at a predetermined distance so that each cradle supports the spaced rails. The support section further includes a lifting mechanism including a lifting member operatively engaged with the base section and the support section to raise and lower the support section.

In some embodiments, the elongate base section further comprises a second plurality of rollers mounted along the axial length perpendicular to the first plurality of rollers. In specific embodiments, the plurality of rollers are wheels.

The elongate base section of detailed embodiments has a top, a front face and a back face defining an inverted elongate u-shape with an open bottom and a cavity therein. In specific embodiments, the first plurality of rollers are wheels located within the cavity and mounted to the elongate base section, a portion of each of the first plurality of wheels projecting from the open bottom of the cavity of the elongate base section. According to some embodiments, each of the wheels are attached to the elongate base section with an axle attached to the front face and the back face of the elongate base section, the wheels being freely rotatable about the axle.

The lifting mechanism of some embodiments further comprises a hinge assembly in contact with a face of the elongate base and a lever arm operatively connected to the hinge assembly so that the lever arm can be moved in an axial and radial direction with respect to the hinge assembly. Moving the lever arm axially does not cause rotation of the hinge assembly. Moving the lever arm radially causes rotation of the hinge assembly and movement of the lifting member in a direction to raise or lower the support section. In specific embodiments, the lifting mechanism further comprises a lever bracket on a face of the elongate base positioned to allow the lever arm to be placed in the lever bracket.

In specific embodiments, the lifting member is operatively engaged with the base section and the support section by an eccentric cam which projects from the elongate base. The eccentric cam operable to change projection from a minimum projection to a maximum projection.

In some embodiments, the first plurality of rollers comprises two proximal wheels positioned proximally of a center point in the elongate base and two distal wheels positioned distally of the center point in the elongate base.

The support section of one or more embodiments further comprises at least one connection hole including a captive knob therein. The captive knob is adapted to cooperatively interact with a hole in the spaced rails on the back side of the photovoltaic module.

In detailed embodiments, the elongate base section is made of galvanized steel with a thickness of at least about 1.5 mm.

Additional embodiments of the invention are directed to dolly kits for moving a planar photovoltaic module having a plurality of spaced rails supporting a back side of the photovoltaic module. The dolly comprises an upper rail dolly and a lower rail dolly. The upper rail dolly comprises an elongate base section and a support section. The elongate base section has an axial length and a first upper plurality of rollers mounted along the axial length of the elongate base section and a second upper plurality of rollers mounted along the axial length of the elongate base in a plane perpendicular to the first plurality of rollers. The support section is movably coupled with the elongate base section such that the support section can be moved upwardly and downwardly to raise and lower the module. The support section includes a plurality of cradles spaced at a predetermined distance so that each cradle supports the spaced rails. The support section further includes a lifting mechanism including a lifting member operatively engaged with the base section and the support section to raise and lower the support section. The lower rail dolly comprises an elongate base section and a support section. The elongate base section has an axial length and a lower plurality of rollers mounted along the axial length of the elongate base section. The support section is movably coupled with the elongate base section such that the support section can be moved upwardly and downwardly to raise and lower the module. The support section includes a plurality of cradles spaced at a predetermined distance so that each cradle supports the spaced rails. The support section further includes a lifting mechanism including a lifting member operatively engaged with the base section and the support section to raise and lower the support section. In detailed embodiments, one or more of the first upper plurality of rollers, the second upper plurality of roller and the lower plurality of rollers are wheels.

Further embodiments of the invention are directed to methods of mounting a photovoltaic module on a support structure having an upper rail and a lower rail, the upper rail having a horizontal rail surface and vertical rail surface and the lower rail having a horizontal rail surface. The methods comprise attaching an upper rail dolly to spaced rails on the back of the photovoltaic module. The upper rail dolly has vertically aligned rollers and horizontally aligned rollers. The upper rail dolly has a cradle for contacting the spaced rails on the back of the photovoltaic module. A lower rail dolly is attached to the spaced rails of the photovoltaic module. The lower rail dolly has vertically aligned rollers and a cradle for contacting the spaced rails on the back of the photovoltaic module. The upper rail dolly is placed on the upper rail of the support structure so the vertically aligned rollers contact the horizontal rail surface and the horizontally aligned rollers contact the vertical rail surface. The lower rail dolly is placed on the lower rail of the support structure so that the vertically aligned rollers contact the horizontal rail surface of the support structure. The cradle of the upper rail dolly and the cradle of the lower rail dolly are lifted to lift the photovoltaic module so that the spaced rails on the back of the photovoltaic module do not contact the support structure. The photovoltaic module is moved along the upper rail and lower rail of the support structure to a mounting location. The cradle of the upper rail dolly and the cradle of the lower rail dolly are lowered to lower the photovoltaic module so that the spaced rails on the back of the photovoltaic module are in contact with the upper rail and lower rail of the support structure. The photovoltaic module is fixed to the support structure.

Detailed embodiments further comprise suspending the photovoltaic module to allow access to the spaced rails on a back of the photovoltaic module and attaching one or more of the upper rail dolly and the lower rail dolly to the spaced rails before placing the one or more dolly on the support structure. In specific embodiments, the photovoltaic module is suspended with a vacuum frame. In specific embodiments the vacuum frame is held by a portable jib boom.

Some embodiments further comprise removing the upper rail dolly from the upper rail of the support structure and removing the lower rail dolly from the lower rail of the support structure after the photovoltaic module is fixed to the support structure.

According to one or more embodiments, the photovoltaic module comprises a plurality of small solar modules that are assembled into a larger array.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a depiction of an aerial view of a solar farm including crane locations and operable radii for each crane location according to a prior art process for mounting photovoltaic modules;

FIG. 2A is a side view of a photovoltaic support structure;

FIG. 2B is an expanded side view of the top end of a photovoltaic support structure taken along section 2B of FIG. 2A.

FIG. 3 is a side view of a lower rail dolly in accordance with one or more embodiments of the invention;

FIG. 4 is a side view of an upper rail dolly in accordance with one or more embodiments of the invention;

FIG. 5 is a perspective view of an upper rail dolly in accordance with one or more embodiments of the invention;

FIG. 6 is an end view of a an upper rail dolly in accordance with one or more embodiments of the invention placed on the expanded side view of the top end of a support structure taken along section 2B of FIG. 2A;

FIG. 7 shows a perspective view of an upper rail dolly in the movable position in accordance with one or more embodiments of the invention;

FIG. 8 shows a perspective view of an upper rail dolly in a mounting position in accordance with one or more embodiments of the invention; and

FIG. 9 shows a schematic of a loading station concept according to one or more embodiments of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the singular forms “a”, “an” and “the” include plural referents unless the context clearly indicates otherwise. For example, reference to a “cell” may also refer to more than one cells, and the like.

The terms “photovoltaic module” and “solar module” are used to describe a device made up of a plurality of individual photovoltaic cells suitable for converting light into electricity.

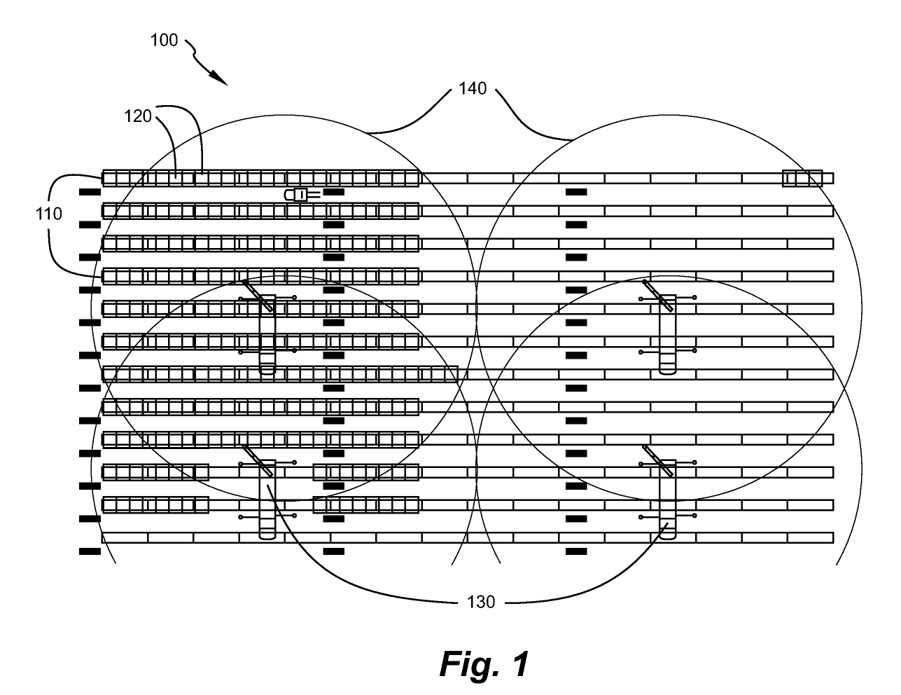

FIG. 1 shows a sketch of an aerial view of a small solar farm 100 containing twelve rows 110 of photovoltaic modules 120. A typical process for mounting these modules 120 involves a four-man team working with a crane 130. The crane 130 must be driven through the farm 100, sweeping back and forth, to install modules 120 along each row 110. FIG. 1 shows four crane positions with the operable radius 140 for each position shown with a circle. To cover all areas of the solar farm 100, it is necessary for the crane positions to be such that the operable radius 140 of one position overlaps with an adjacent position, as shown in the Figure. This process is very time consuming as it requires the crane to be routinely repositioned to access a different area of the solar farm. Additionally, the terrain and soil conditions can make moving large equipment through the farm very difficult or sometimes impossible. Deep mud or soft sand are two examples of poor soils that may prohibit crane movement. It is also an expensive process because it requires four people and a mobile crane unit.

Although not exactly to scale, the solar farm 100 of FIG. 1 has twelve rows with each having an approximate length of 50 meters. A typical 1 MW solar farm has more than 40 rows with each being larger than about 100 meters in length. Obviously, to cover a 1 MW solar farm, a crane would need to be relocated many times over potentially rough terrain and soil, an inefficient and costly proposition at best.

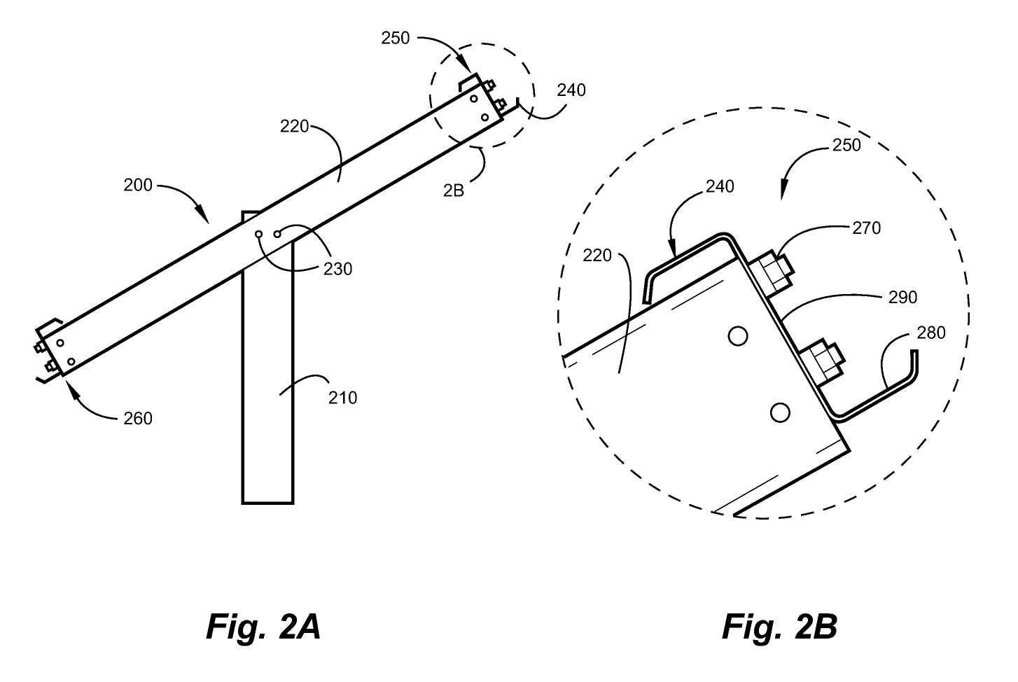

FIG. 2A shows a common support structure 200 used in many solar farms. The support structures include a ground penetrating post 210 with angled supports 220 for holding the solar modules. The ground penetrating post 210 may be made from galvanized steel and roll formed. The angled supports 220 are connected to the ground penetrating post 210 by bolts 230 positioned through slots (not shown) in either the post 210 or angled supports 220. The slots allow the angle of the angled supports 220 to be changed depending on the location and needs of the solar farm.

The angled supports 220 include a zee purlin cross supports, also referred to as z-track 240. An upper rail 250 is located on the top end and a lower rail 260 is located on the bottom end of the angled supports 220. FIG. 2B shows an expanded view of the top end 250 of the angled support 220. A z-track 240 is shown attached to the top end 250 of the angled support 220 using a pair of bolts 270. These bolts 270 are optional and can be replaced by any suitable connection means. The z-track 240 includes a horizontal rail surface 280 and a vertical rail surface 290. It can be seen from FIG. 2B that the horizontal rail surface 290 is not perfectly horizontal, but at an angle approximately equal to that of the angled support 220. As used in this specification and the appended claims, the term “horizontal rail surface” means the lower z-track 240 surface that is about collinear with angled support 220, as shown in FIG. 2B. It can also be seen from FIG. 2B that the vertical rail surface 290 is not perfectly vertical, but an angle approximately 90° from that of the angled support 220. As used in this specification and the appended claims, the term “vertical rail surface” means the portion of the z-track 240 that is substantially perpendicular to the long axis of the angled support 220 and/or substantially perpendicular to the horizontal rail surface 280, as shown in FIG. 2B.

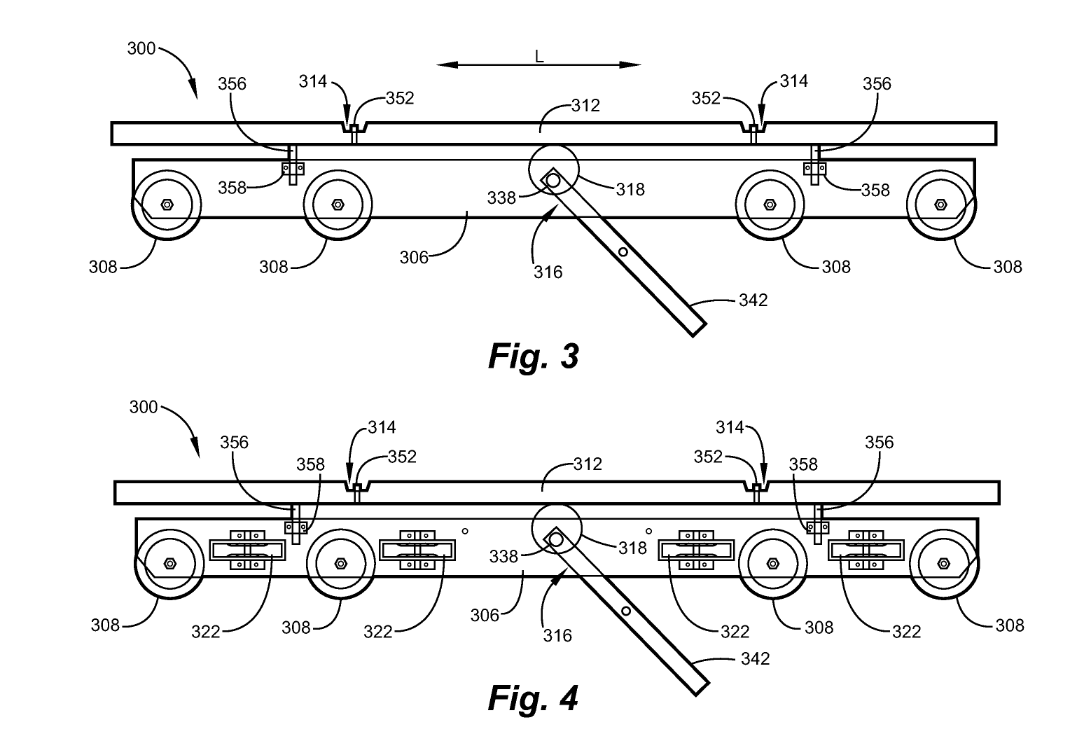

One or more embodiments of the invention are directed to photovoltaic module dollies that can use the z-tracks 240 of existing support structures 200 as a rail for sliding a module. FIGS. 3-8 show representative embodiments of a module dolly 300 and use. These embodiments are merely illustrative and should not be taken as limiting the scope of the invention. The Figures show various embodiments of a dolly 300 for moving a substantially planar photovoltaic module 302 are shown. As used in this specification and the appended claims, the term “substantially planar” means that the photovoltaic module is reasonably flat, i.e., not so non-planar that the module does not function as intended. The photovoltaic modules 302 for use with some embodiments have a plurality of spaced rails 304 supporting a back side of the photovoltaic module 302. Specific embodiments of the invention are intended for use with photovoltaic modules 302 having four spaced rails 304.

The dolly 300 includes an elongate base section 306 having an axial length L and a first plurality of rollers 308 mounted along the axial length L of the elongate base section 306. A support section 312 is movably coupled with the elongate base section 306 such that the support section 312 can be moved upwardly and downwardly to raise and lower the photovoltaic module 302. The support section 312 includes a plurality of cradles 314 spaced at a predetermined distance so that each cradle 314 supports a spaced rail 304. The support section 312 further includes a lifting mechanism 316 including a lifting member operatively engaged with the base section 306 and the support section 312 to raise and lower the support section 312.

In specific embodiments, the elongate base section 306 further comprises a second plurality of rollers 322 mounted along the axial length L in a direction perpendicular to the first plurality of rollers 308.

Embodiments of the invention include rollers which can be any number of suitable roller devices. Suitable examples include, but are not limited to, wheels and ball bearings. In detailed embodiments, one or more of the first plurality of rollers 308 and second plurality of rollers 322 are wheels. In specific embodiments the wheels have a diameter greater than about 30 mm. In other embodiments, the wheels have a diameter about 40 mm. The embodiments shown in FIGS. 3 through 8 use wheels for both the first plurality of rollers 308 and the second plurality of rollers 322.

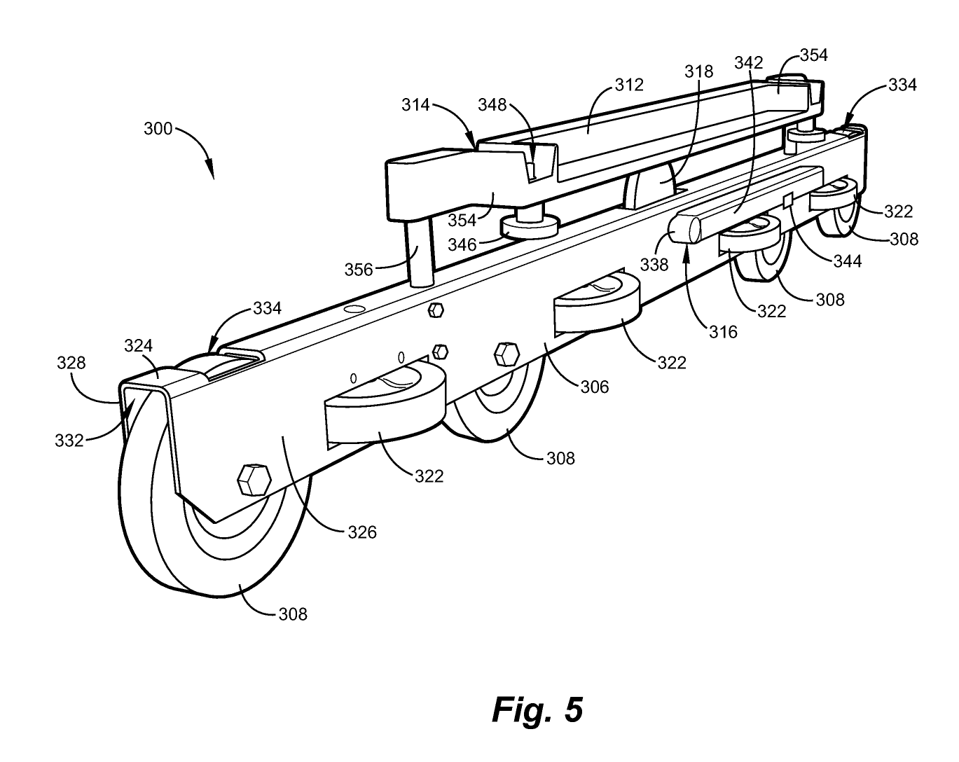

The elongate base section 306 can be any suitable shape. In specific embodiments, as best shown in FIGS. 5 to 7, the elongate base section 306 has a top 324, a front face 326 and a back face 328 defining an inverted elongate u-shape with an open bottom and a cavity 322 therein. In some detailed embodiments, the first plurality of rollers 308 are located in the cavity 322 and are mounted to the elongate base section 306 and the bottom portions project from open bottom of the cavity 332 in the elongate base section 306. In some embodiments, the top portion of the first plurality of rollers 308 may extend through openings 334 in the top 324 of the elongate base section 306, as shown in FIG. 5. The openings 334 in specific embodiments are positioned over the outside rollers only. These openings 334 may allow the outside rollers to move upwardly when the dolly is crossing gaps in the support structures 200.

In detailed embodiments, each of the first plurality of rollers 308 are wheels which are attached to the elongate base section 306 with an axle 336 which is attached to the front face 326 and the back face 328 of the elongate base section 308. The first plurality of rollers 308 being freely rotatable about the axle 336.

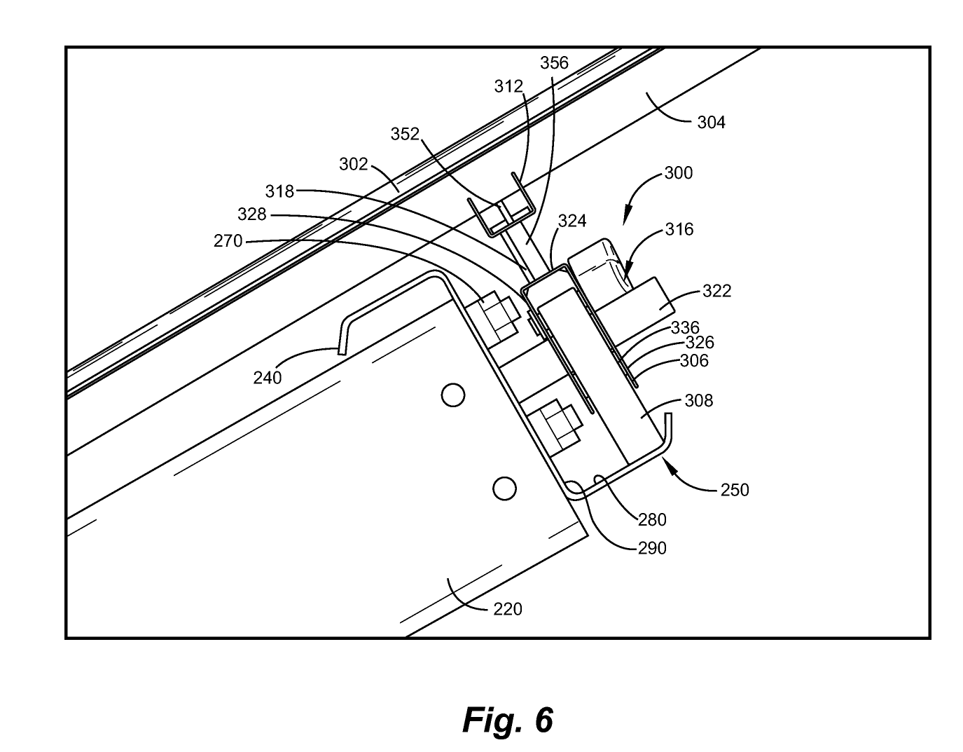

In one or more embodiments of the invention, the lifting mechanism 316 further comprises a hinge assembly 338 in contact with either the front face 326 or the back face 328 of the elongate base section 306. A lever arm 342 may be operatively connected to the hinge assembly 338 so that the lever arm 342 can be moved in an axial and radial direction with respect to the hinge assembly 338. Referring to FIG. 6, movement of the lever arm 342 axially means that the lever arm 342 moves along about the same axis as the second plurality of rollers 322. Axial movement of the lever arm does not cause rotation of the hinge assembly 338. Movement of the lever arm 342 radially causes the hinge assembly 338 to rotate, causing movement of the lifting member 318 in a direction to raise or lower the support section 312. This combination of axial and radial motion allows the lever arm 342 to be pressed against the front face 326 of the elongate base section 306 when not actively being used to ensure that the lever arm 342 is not in the way. When not in active use, the lever arm 342 may be placed in a lever bracket 344 attached to the front face 326 of the elongate base section 306.

When needed, the lever arm 342 can be moved axially by any amount from about 0° to about 180°, allowing radial movement of lever arm 342 to be transferred to the hinge assembly 338 and cause the hinge assembly 338 to rotate. In specific embodiments, the lever arm 342 can be moved axially less than about 90° relative to the front face 326 of the elongate base section 306. In other embodiments, the lever arm 342 can be moved axially less than about 80°, 70°, 60°, 50°, 45°, 40° or 30° relative to the front face 326 of the elongate base section 306.

In specific embodiments, the lifting member 318 is operatively engaged with the elongate base section 306, and the support section 312 is an eccentric cam. This cam, which can be seen in FIGS. 3 and 4, projects from the elongate base section 306 to a varying degree depending on the position of the lever arm 342. Movement of the lever arm 342 causes the lifting member 318 to change projection from a minimum projection to a maximum project. In detailed embodiments, the lifting member 318 provides a lift travel of about 35 mm. In various embodiments, the lifting member 318 or eccentric cam provides a lift travel of greater than about 20 mm, 25 mm, 30 mm, 35 mm or 40 mm. In specific embodiments, the lifting member 318 is an eccentric cam. In one or more embodiments, the lifting member 318 includes a pneumatic or hydraulic cylinder, ball screw, cable assembly with linear guides, levers and combinations thereof. This preceding list of lifting members are merely illustrative and should not be taken as limiting the scope of the invention.

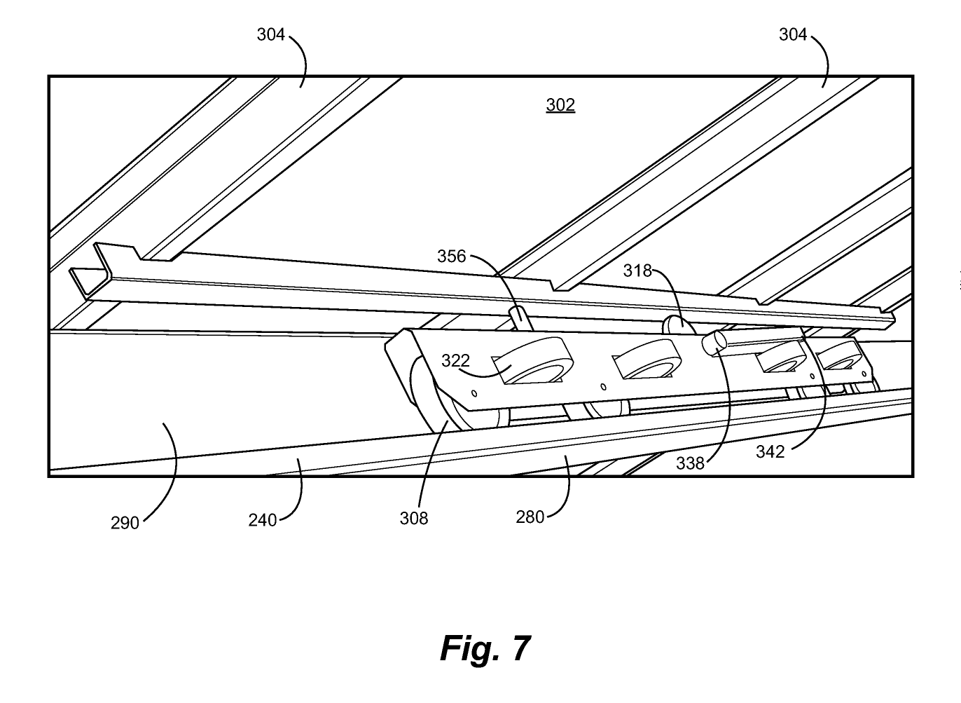

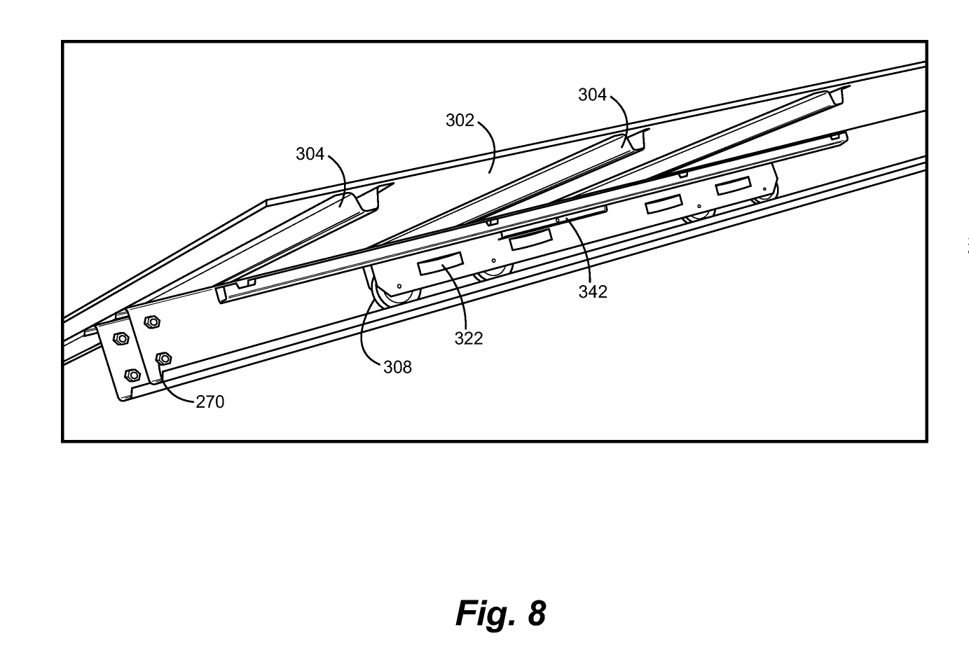

The movement from the minimum projection to the maximum projection is exemplified in the embodiments shown in FIGS. 7 and 8. FIG. 7 shows a dolly 300 supporting a photovoltaic module 302 in the in the movable position. The support section 312 of the dolly 300 is in the raised position which holds the module 302 off of the angled supports 220 and the z-track 240. The lever arm 342 is positioned toward the distal end of the dolly 300, shown as the right side of the dolly in FIG. 4. With the lever arm 342 in this position, the hinge assembly 338 is rotated to a position where the lifting member 318 is in a position of maximum projection. In some embodiments, the lever arm 342 rests in a lever bracket 344, which helps prevent the weight of the module 302, i.e., pressure applied to the lifting member 318, from causing or forcing the lifting member 318 into a lowered position causing the hinge assembly 338 to rotate. It should be understood that the direction of the lever arm 342 does not need to be distally directed to cause the lifting member 318 to be in the position of maximum projection, and can be reversed, or in other configurations.

FIG. 8 shows the dolly 300 of FIG. 7 in the mounting position. The dolly 300 has been moved along the z-track 240 to the desired mounting position. The photovoltaic module 302 has been attached to the angled supports 220 and the support section 312 is no longer in contact with the spaced rails 304. The lever arm 342 is directed toward the proximal end of the dolly 300 in FIG. 8. As there is no pressure applied to the support section 312 in this position, there is little reason for a lever bracket 344 on this side. However, in some embodiments there is a lever bracket 344 on the side of the dolly 300 which represents the lowered position for the support section 312. The lever bracket 344 in these cases can be used to ensure that the lever arm 342 remains safely out of the way during movement of the dolly 300. With the support section 312 in the lowered position, there is a gap between the support section 312 and the spaced rails 304 on the module 302. The gap allows the dolly 300 can be removed from the z-track 240 without affecting the position of the module 302 as the module 302 has already be affixed into place on the support structure 200. In detailed embodiments, the gap is up to about 10 mm. In specific embodiments, the gap is in the range of about 5-6 mm. In various embodiments, the gap is greater than about 1 mm, 2 mm, 3 mm, 4 mm, 5 mm, 6 mm, 7 mm, 8 mm or 9 mm.

The support section 312 of some embodiments is further supported by at least one shaft 356. The at least one shaft 356 can be connected to the support section 312 by any suitable means. In detailed embodiments, the shaft 356 is threaded into the support section 312. The at least one shaft 356 may help provide additional lateral support to the dolly 300 helping to prevent the support section 312 from twisting substantially out of alignment with the elongate base section 306. In specific embodiments, the elongate base section 306 further comprises at least one shaft bracket 358 positioned to cooperatively interact with the shaft 356. The shaft bracket 358 may also help provide lateral support to the dolly 300 by supporting the shafts 356 which in turn provide support for the support section 312.

In detailed embodiments, as shown in FIG. 5, the first plurality of rollers 308 comprises two proximal wheels positioned proximally of a center point in the elongate base section 306 and two distal wheels positioned distally of the center point in the elongate base section 306. In specific embodiments, the second plurality of rollers 322 comprise two proximal wheels positioned proximally of a center point in the elongate base section 306 and two distal wheels position distally of the center point in the elongate base section 306. The first plurality of rollers 308 and the second plurality of rollers 322 may be split into groups with individual rollers separated to allow the dolly to pass over small gaps in the z-track 240. This allows one roller or set of rollers can take the load while the other roller or set of rollers is over the gap.

In some embodiments, as shown in FIG. 4, the first plurality of rollers 308 comprise two left half wheels positioned to the left of a center point in the elongate base section 306. The second plurality of rollers 322 may comprise two right half wheels positioned to the right of a center point in the elongate base section 306. The splitting of the wheels into two sets of two wheels enables the dolly 300 to roll across breaks in the z-track 240 without being dislodged.

The wheels can be spaced in any number of configurations. In specific embodiments, where one or more of the first plurality of wheels 308 and the second plurality of wheels 322 are split into two groups of two, the groups are separated by a distance in the range of about 700 to about 1000 mm (measured on centers). In specific embodiments, the groups are separated by a distance of about 860 mm (measured on centers). In some embodiments with the same split design, the two left half (or proximal wheels) and/or the two right half (or distal wheels) are separated by a distance in the range of about 200 mm to about 350 mm (measured on center). In specific embodiments, the distance is about 280 MM.

The plurality of cradles 314 in the support section 312 can be any suitable shape for interacting with the spaced rails 304 on the back of the photovoltaic module 302. The cradles 314 shown in FIGS. 6-8 are u-shaped recesses in the support section 312 which are sized to cooperatively interact with the spaced rails 304. In FIG. 5, the cradles 314 further comprise wings 354 which extend size of the support section 312 in a direction perpendicular to the axial length L of the dolly 300. The wings 354 increase the surface area of the spaced rails 304 that the support section 312 contacts. The length of the wings 354 can be adjusted as needed. In some embodiments, the cradles 314 have wings 354 which extend to both sides of the dolly 300. The larger cradles 314 may provide greater stability and help prevent twisting of the dolly 300 under strain.

Additionally, the support section of detailed embodiments includes a retention member. The retention member can be any number of suitable connection mechanisms and are not limited to the mechanisms described here. In some embodiments, the support section 312 includes at least one pin 352 which can be inserted into a hole (not shown) in the spaced rails 304. The pin 352 can be located in the cradles 314 and helps prevent the module 302 from sliding off of the dolly 300.

To secure the photovoltaic module 302 to the support section 312 of the dolly 300, some embodiments further comprise at least one connection hole 348 in the support section 312, or in the cradle 314. The connection hole 348 may be threaded or unthreaded and may include a captive knob 346 inserted therein. The captive knob 346 may be adapted to cooperatively interact with a hole (not shown) in the spaced rails 304 on the back side of the photovoltaic module 302. This allows the user to easily secure the dolly 300 to the back of the photovoltaic module 302 without the need for additional tools.

The elongate base section 306 and/or the support section 312 can be made of any suitable material, including but not limited to aluminum, steel, galvanized steel, painted or powder coated materials, carbon graphite and high strength aluminum extrusions. In detailed embodiments, the elongate base section 306 and/or the support section 312 are made from steel or galvanized steel. In specific embodiments, the elongate base section 306 and/or the support section 312 is made from a galvanized steel with a thickness of at least about 1.5 mm. In various embodiments, the elongate base section 306 and/or the support section 312 are made from galvanized steel with a thickness of at least about 1 mm, 2 mm, 2.25 mm, 2.5 mm, 2.75 mm or 3 mm.

In some embodiments, the elongate base section 306 includes at least one additional riveted stiffener (not shown) to prevent twisting of the dolly 300 under strain from the weight of the photovoltaic module 302. The at least one stiffener may be used in embodiments where the elongate base section 306 includes an opening, like the cavity 332 previously described. In one or more embodiments, the elongate base section 306 is bolted or welded to provide additional stiffness and/or prevent twisting.

Additional embodiments of the invention are directed to dolly kits for moving a planar photovoltaic module. The dolly kits comprise two separate dolly units, an upper rail dolly and a lower rail dolly. Both dollies are designed based on the embodiments previously described. The upper rail dolly, shown in FIGS. 4-8 includes a first plurality of rollers 308 and a second plurality of rollers 322. The first plurality of rollers 308 ride along the horizontal rail surface 280 of the z-track 240, and the second plurality of rollers 322 ride along the vertical rail surface 290 of the z-track 240. The combination of the first plurality of rollers 308 and the second plurality of rollers 322 provide both vertical and lateral support. The lower rail dolly, shown in FIG. 3 includes a lower plurality of rollers which are similar to the first plurality of rollers 308 in the upper rail dolly.

Further embodiments of the invention are directed to methods of mounting a photovoltaic module 302 on a support structure 200 having an upper rail 250 and a lower rail 260. The upper rail 250 has a horizontal rail surface 280 and vertical rail surface 290 and the lower rail 250 has a horizontal rail surface which is a mirror image of the z-track on the upper rail 250. An upper rail dolly, as shown in FIG. 4, is attached to spaced rails 304 on the back of the photovoltaic module 302. The upper rail dolly has a first plurality of rollers 308 which are vertically aligned and second plurality of rollers 322 which are horizontally aligned. The first plurality of rollers 308 may also be referred to as the vertically aligned rollers and the second plurality of rollers 322 may also be referred to as horizontally aligned rollers. The upper rail dolly has at least one cradle 314 for contacting the spaced rails 304 on the back of the photovoltaic module 302. A lower rail dolly, as in FIG. 3, is attached to the spaced rails 304 of the photovoltaic module 302. The lower rail dolly has vertically aligned rollers and at least one cradle 314 for contacting the spaced rails 304 on the back of the photovoltaic module 302.

The upper rail dolly is placed on the on the upper rail 250 of the support structure 200 so the vertically aligned rollers contact the horizontal rail surface 280 and the horizontally aligned rollers contact the vertical rail surface 290. The lower rail dolly is placed on the lower rail 260 of the support structure 200 so that the vertically aligned rollers contact the horizontal rail surface 280 of the support structure 200. Whether the upper rail dolly or the lower rail dolly is placed on the respective rails first is not important and should not be taken as limiting the scope of the invention. In detailed embodiments, the upper rail dolly is placed on the upper rail 250 first. In some embodiments, the lower rail dolly is placed on the lower rail 260 first. In specific embodiments, the upper rail dolly is placed on the upper rail 250 and the lower rail dolly is placed on the lower rail 260 at substantially the same time.

The at least one cradle 314 of the upper rail dolly and the at least one cradle 314 of the lower rail dolly are lifted by lifting the support section 312 of the respective dolly 300 to lift the photovoltaic module 302 so that the spaced rails 304 on the back of the photovoltaic module 302 do not contact the support structure 200. The support sections 312 can be lifted to the elevated position before or after placing the respective dolly onto the respective rail. In some embodiments, the support sections 312 are lifted prior to placing the dollies on the rails. In various embodiments, the supports section 312 are lifted after placing the dollies on the rails.

Once both the upper rail dolly and the lower rail dolly have the support sections 312 containing the cradles 314 in the elevated position, the photovoltaic module 302 is moved along the upper rail 250 and lower rail 260 of the support structure 200 to a location where the module 302 will be mounted. The module can then be attached to the support structure 200 by any suitable means.

After the photovoltaic module 203 has been affixed to the support structure 200, the support section 312 including the at least one cradles 314 of the upper rail dolly and the lower rail dolly are lowered. Once the supports sections 312 are in the lowered position, the spaced rails 304 on the back of the photovoltaic module 302 are in contact with the upper rail 250 and lower rail 260 of the support structure 200 and the dollies can be removed.

If the support sections 312 are connected to the spaced rails 304 by, for example, a captive knob 346, the support section 312 is lowered in at least two stages. First the support section 312 is lowered to allow the spaced rails to rest on the support structure 200. After the module 302 is affixed to the support structure, the support section 312 can be disconnected from the spaced rails 304 and lowered completely. Once completely lowered, the dolly can be removed from the z-track without disturbing the mounted module.

In some embodiments, the photovoltaic module 302 is suspended to allow access to the spaced rails 304 on a back of the photovoltaic module 302. While suspended, one or more of the upper rail dolly and the lower rail dolly are attached to the spaced rails 304 before placing the one or more dolly on the support structure 200. In specific detailed embodiments, the photovoltaic module 302 is suspended with a vacuum frame. In specific embodiments, the vacuum frame is held by a portable jib boom 900.

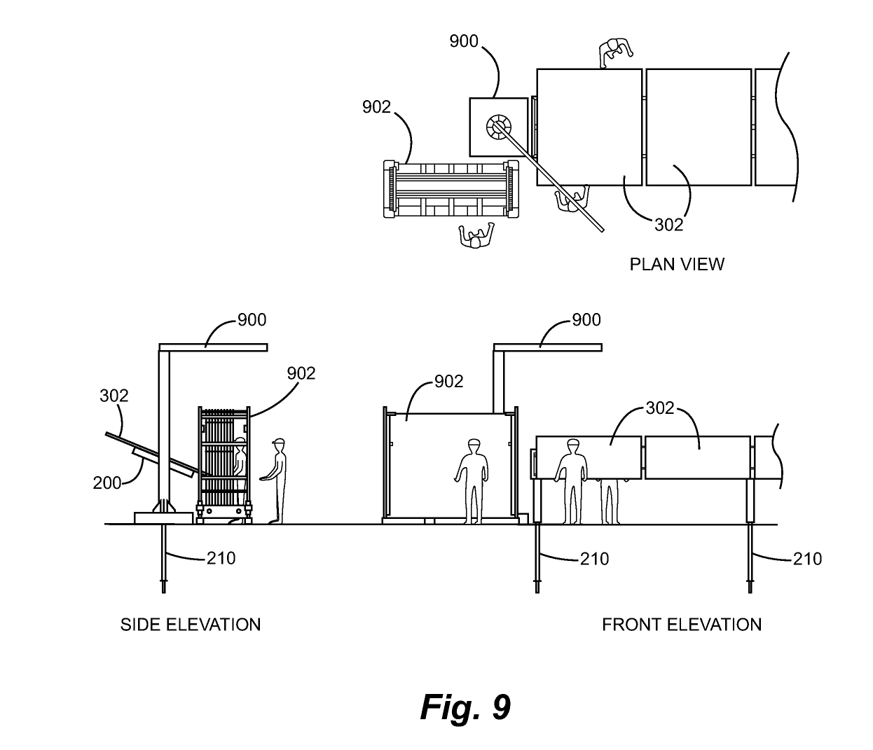

FIG. 9 shows a loading station concept in accordance with the various embodiments of the invention. A portable jib boom 900 can be positioned at the end of a row 110 in solar farm 100. A module shipping rack 902 can be positioned within reach of the jib boom 900. An individual module 302 can be lifted on the jib boom 900 and the dollies can be attached to the spaced rails 304 on the back. The jib boom 900 can then pivot to allow the dollies to be placed on the rails of the support structure 200. Once on the rails, the module 302 can be slid down the support structure 200 and affixed in place. In some embodiments, the jib boom 900 is affixed with a vacuum frame (not shown) which allows the individual photovoltaic modules 302 to be easily lifted without damaging the surface.

This allows the entire row of the solar farm to be populated with photovoltaic modules without having to relocate the jib boom 900 or the module shipping rack 902. Depending on the size and reach of the jib boom 900, more than one row of the solar farm could be populated without needing to relocated the jib boom 900 or the module shipping rack 902. This will allow 2 or 3 people to install the modules in the entire solar farm with relatively small and portable equipment. Additionally, when relocation of the jib boom 900 is necessary, the jib boom 900 needs to be moved along the edges of the array or through aisleways. These areas are typically leveled and/or compacted for future array service and/or emergency access. Therefore, the jib boom 900 does not need to be moved over potentially rough terrain or through difficult soil conditions.

The module dollies supporting the individual module 302 can be pushed through the solar farm by a human. Additionally, the module 302 could be propelled through the farm on the dollies 300 in a variety of ways, including but not limited to, pulley systems and electric motors. In specific embodiments, the dolly 300 is fitted with an electric motor adapted to propel the dolly 300 laden with a module 302 along the length of the z-track 240 in a solar farm. In more specific embodiments, the dolly 300 has an electric motor powered by the solar module 302 being supported by the dolly 300.

The dolly 300 and installation methods have been described with respect to moving and supporting large scale (i.e., 5.7 m²) modules. It should be understood that the dolly 300 and methods are also applicable to small solar panels, especially when the small solar panels have been pre-assembled into a larger array.

Reference throughout this specification to “one embodiment,” “certain embodiments,” “one or more embodiments,” “an embodiment,” “one aspect,” “certain aspects,” “one or more embodiments” and “an aspect” means that a particular feature, structure, material, or characteristic described in connection with the embodiment is included in at least one embodiment of the invention. Thus, the appearances of the phrases such as “in one or more embodiments,” “in certain embodiments,” “in one embodiment,” “in an embodiment,” “according to one or more aspects,” “in an aspect,” etc., in various places throughout this specification are not necessarily referring to the same embodiment or aspect of the invention. Furthermore, the particular features, structures, materials, or characteristics may be combined in any suitable manner in one or more embodiments or aspects. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. A dolly for moving a planar photovoltaic module having a plurality of spaced rails supporting a back side of the photovoltaic module, the dolly comprising:
an elongate base section having an axial length and a first plurality of rollers mounted along the axial length of the elongate base section; and
a support section movably coupled with the elongate base section such that the support section can be moved upwardly and downwardly to raise and lower the photovoltaic module; the support section including a plurality of cradles spaced at a predetermined distance so that each cradle supports the spaced rails, and the support section further including a lifting mechanism including a lifting member operatively engaged with the base section and the support section to raise and lower the support section.

2. The dolly of claim 1, wherein the elongate base section further comprises a second plurality of rollers mounted along the axial length perpendicular to the first plurality of rollers.

3. The dolly of claim 1, wherein the plurality of rollers are wheels.

4. The dolly of claim 1, wherein the elongate base section has a top, a front face and a back face defining an inverted elongate u-shape with an open bottom and a cavity therein.

5. The dolly of claim 4, wherein the first plurality of rollers are wheels located within the cavity and mounted to the elongate base section, a portion of each of the first plurality of wheels projecting from the open bottom of the cavity of the elongate base section.

6. The dolly of claim 5, wherein each of the wheels are attached to the elongate base section with an axle attached to the front face and the back face of the elongate base section, the wheels being freely rotatable about the axle.

7. The dolly of claim 1, wherein the lifting mechanism further comprises a hinge assembly in contact with a face of the elongate base and a lever arm operatively connected to the hinge assembly so that the lever arm can be moved in an axial and radial direction with respect to the hinge assembly, where moving the lever arm axially does not cause rotation of the hinge assembly and moving the lever arm radially causes rotation of the hinge assembly and movement of the lifting member in a direction to raise or lower the support section.

8. The dolly of claim 1, wherein the lifting member operatively engaged with the base section and the support section is an eccentric cam which projects from the elongate base, the eccentric cam operable to change projection from a minimum projection to a maximum projection.

9. The dolly of claim 1, wherein the first plurality of rollers comprises two proximal wheels positioned proximally of a center point in the elongate base and two distal wheels positioned distally of the center point in the elongate base.

10. The dolly of claim 1, wherein the support section further comprises at least one connection hole including a captive knob therein, the captive knob adapted to cooperatively interact with a hole in the spaced rails on the back side of the photovoltaic module.

11. The dolly of claim 1, wherein the elongate base section is made of galvanized steel with a thickness of at least about 1.5 mm.

12. The dolly of claim 7, wherein the lifting mechanism further comprises a lever bracket on a face of the elongate base positioned to allow the lever arm to be placed in the lever bracket.

13. A dolly kit for moving a planar photovoltaic module having a plurality of spaced rails supporting a back side of the photovoltaic module, the dolly comprising:
an upper rail dolly comprising:
an elongate base section having an axial length and a first upper plurality of rollers mounted along the axial length of the elongate base section and a second upper plurality of rollers mounted along the axial length of the elongate base in a plane perpendicular to the first plurality of rollers, and
a support section movably coupled with the elongate base section such that the support section can be moved upwardly and downwardly to raise and lower the module; the support section including a plurality of cradles spaced at a predetermined distance so that each cradle supports the spaced rails, and the support section further including a lifting mechanism including a lifting member operatively engaged with the base section and the support section to raise and lower the support section; and
a lower rail dolly comprising:
an elongate base section having an axial length and a lower plurality of rollers mounted along the axial length of the elongate base section, and
a support section movably coupled with the elongate base section such that the support section can be moved upwardly and downwardly to raise and lower the module; the support section including a plurality of cradles spaced at a predetermined distance so that each cradle supports the spaced rails, and the support section further including a lifting mechanism including a lifting member operatively engaged with the base section and the support section to raise and lower the support section.

14. The dolly of claim 13, wherein one or more of the first upper plurality of rollers, the second upper plurality of roller and the lower plurality of rollers are wheels.

15. A method of mounting a photovoltaic module on a support structure having an upper rail and a lower rail, the upper rail having a horizontal rail surface and vertical rail surface and the lower rail having a horizontal rail surface, the method comprising:
attaching an upper rail dolly to spaced rails on the back of the photovoltaic module, the upper rail dolly having vertically aligned rollers and horizontally aligned rollers, the upper rail dolly having a cradle for contacting the spaced rails on the back of the photovoltaic module;
attaching a lower rail dolly to a the spaced rails of the photovoltaic module, the lower rail dolly having vertically aligned rollers, the lower rail dolly having a cradle for contacting the spaced rails on the back of the photovoltaic module;
placing the upper rail dolly on the upper rail of the support structure so the vertically aligned rollers contact the horizontal rail surface and the horizontally aligned rollers contact the vertical rail surface;
placing the lower rail dolly on the lower rail of the support structure so that the vertically aligned rollers contact the horizontal rail surface of the support structure;
lifting the cradle of the upper rail dolly and the cradle of the lower rail dolly to lift the photovoltaic module so that the spaced rails on the back of the photovoltaic module do not contact the support structure;
moving the photovoltaic module along the upper rail and lower rail of the support structure to a mounting location;
lowering the cradle of the upper rail dolly and the cradle of the lower rail dolly to lower the photovoltaic module so that the spaced rails on the back of the photovoltaic module are in contact with the upper rail and lower rail of the support structure; and
fixing the photovoltaic module to the support structure.

16. The method of claim 15, further comprising suspending the photovoltaic module to allow access to the spaced rails on a back of the photovoltaic module and attaching one or more of the upper rail dolly and the lower rail dolly to the spaced rails before placing the one or more dolly on the support structure.

17. The method of claim 15, further comprising removing the upper rail dolly from the upper rail of the support structure and removing the lower rail dolly from the lower rail of the support structure after the photovoltaic module is fixed to the support structure.

18. The method of claim 16, wherein the photovoltaic module is suspended with a vacuum frame.

19. The method of claim 18, wherein the vacuum frame is held by a portable jib boom.

20. The method of claim 15, wherein the photovoltaic module comprises a plurality of small solar modules that are assembled into a larger array.
